(19) United States
(12) Patent Application Publication
(10) Pub. No.: US 2008/0088805 A1
(43) Pub. Date: Apr. 17, 2008

(54) OPTICAL PROJECTION APPARATUS AND LIGHT INTEGRATION ROD THEREOF

(75) Inventors: Cheng Wang, Hsinchu (TW); Shih-Ming Wang, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/782,857

(22) Filed: Jul. 25, 2007

(30) Foreign Application Priority Data
Oct. 13, 2006 (TW) 95137683

(51) Int. Cl. F21V 5/02; G03B 21/14

(52) U.S. Cl. 353/97; 362/355

(57) ABSTRACT

A light integration rod is suitable for an optical projection apparatus to uniform the light beam provided by a light source of the optical projection apparatus. The light integration rod has an optical axis and includes a first integration portion. The first integration portion has a light incident cross-section perpendicular to the optical axis and located adjacent to the light source. The space enclosed by the first integration portion is composed of a prism-like space and at least an oblique-pyramid-like space protruded from the first integration portion and the cross-sections of the oblique-pyramid-like space perpendicular to the optical axis are gradually shrunk in the direction from the light incident cross-section to away from the light incident cross-section. In this way, the light integration rod has higher light-collecting efficiency and optical efficiency.

### CROSS-REFERENCE TO RELATED APPLICATION

This application claims the priority benefit of Taiwan application serial no. 95137683, filed on Oct. 13, 2006. All disclosure of the Taiwan application is incorporated herein by reference.

### BACKGROUND OF THE INVENTION

1. Field of the Invention

The present invention generally relates to a display apparatus and alight-uniform component thereof, and more particular, to an optical projection apparatus and a light integration rod thereof.

2. Description of Related Art

Along with the progress of the modern video technology, optical projection apparatuses have been broadly applied in many situations, such as home theater, mini-conference presentation and studio discussion. An optical projection apparatus includes a light source, a light valve and a projection lens. The light source is for providing an illumination light beam, the light valve is for converting the illumination light beam into an image light beam, and the projection lens is for projecting the image light beam onto a screen to display images. Generally, in order to provide the image with uniform brightness, the optical projection apparatus has a light integration rod to uniform the illumination light beam provided by the light source.

Referring to FIGS. 1A and 1B, a conventional light integration rod 100 is composed of four plates 110a, 110b, 110c and 110d, wherein the plates 110a, 110b, 110c and 110d are adhered to each other with glue to enclose a cuboid space (right rectangular prism space), and the inner walls of the plates 110a, 110b, 110c and 110d are plated with high-reflectance material. The light beams provided from the illumination light beam (not shown) is incident into the light integration rod 100 in different angles through the light incident cross-section Cᵢₙ., the light beam would be continuously reflected in the cuboid space to get more uniform, followed by exiting from the light emerging cross-section Cₒᵤₜ of the light integration rod 100.

In general, the longer the light integration rod 100 is, the more uniform the light beam will be after passing through the light integration rod 100. However, the above-mentioned positive mechanism also brings up a dilemma that too many reflections for the light beam in the light integration rod 100 occurs, wherein every reflection would make the light beam lose a portion of energy and lead to a decreased the brightness of the light beam at the light emerging cross-section. Conversely, the shorter the light integration rod 100 is, the fewer reflections for the light beam in the light integration rod 100 will be. Even less energy of the light beam is got lost, the light beam fails to get the desired uniformity emitting out from the light emerging cross-section as a result of inadequate number of the reflections.

FIG. 1C is a sectional diagram of the light integration rod of FIG. 1A along the light incident cross-section. Referring to FIG. 1C, the cross-section of a light beam 50 generally has a circle shape; instead, the light incident cross-section Cᵢₙ has a rectangle shape. Thus, a partial region 52 of the light beam 50 is beyond the light incident cross-section Cᵢₙ without being effectively used. Besides, the light beam 50 is generally provided by, for example, an arc-discharge lamp. When the arc gap is increased due to aging of the arc-discharge lamp, the cross-section area of the light beam 50 accordingly gets bigger, which causes a bigger region of the light beam 50 beyond the light incident cross-section Cᵢₙ to significantly reduce the light-collecting efficiency of the light integration rod 100 and deteriorate the uniformity of the images provided by the optical projection apparatus.

Once the specifications of the light source and the light valve in an optical projection apparatus are determined, the Etendue E of the system may be calculated by E=πA_{beam} sin² θ, wherein A_{beam} represents the area of the light beam cross-section on the light valve and θ is the tolerable divergence angle of the light beam incident onto the light valve. The area of the light beam cross-section at the light incident cross-section and the tolerable divergence angle at the light incident cross-section may be derived from the Etendue E of an optical system at the light source. Only the light within the tolerable divergence angle may be effectively entered into the imaging system. Therefore, limited by the tolerable divergence angle of the system, a conventional light integration rod 100 fails to effectively achieve the satisfied light-collecting efficiency and optical efficiency.

By conducting an optical simulation on the light integration rod 100 of FIG. 1A, when the profile dimension thereof is 5.54 mm×3.08 mm×30 mm and the light beam intensity at the light source is A, the light beam intensity at the light emerging cross-section may be obtained as 5482.5 lumin (lm). Further, when the profile dimension of a light integration rod is 5.36 mm×3.65 mm×34.9 mm and the tolerable divergence angle at the light incident cross-section is 30°, it may be seen from FIGS. 1D and 1E that the light-collecting efficiency at the light incident cross-section is 63.9% by the simulation, which is corresponding to 100% of the total light throughout at the light source. With no consideration of any reflection loss of the light beam within the light integration rod, the optical efficiency at the light emerging cross-section is 63.9% as well.

### SUMMARY OF THE INVENTION

Accordingly, the present invention is directed to provide a light integration rod having better light-collecting efficiency and optical efficiency.

The present invention is directed to provide an optical projection apparatus having a light integration rod with better light-collecting efficiency and optical efficiency, so that the optical projection apparatus has better display quality.

As embodied and broadly described herein, the present invention provides a light integration rod for uniforming the light beam provided by a light source of an optical projection apparatus. The light integration rod has an optical axis and includes a first integration portion. The first integration portion has a light incident cross-section perpendicular to the optical axis and located adjacent to the light source, wherein the first integration portion encloses a space composed of a prism-like space and at least an oblique-pyramid-like space. The oblique-pyramid-like space has a base located on the light incident cross-section and is protruded from a cross-section of the first integration. The cross-sections of the oblique-pyramid-like space are gradually shrunk from the light incident cross-section in the direction away from the light incident cross-section.

As embodied and broadly described herein, the present invention provides an optical projection apparatus, which includes a light source, a light integration rod mentioned above, a light valve and an imaging system. The light source provides an illumination light beam and the light integration rod is disposed on the optical path of the illumination light beam and the illumination light beam is incident into the light integration rod from the light incident cross-section along a direction parallel to the optical axis of the light integration rod. The light valve is disposed on the optical path of the illumination light beam after passing through the light integration rod and suitable for converting the light beam into an image light beam, while the imaging system is disposed on the optical path of the illumination light beam.

As embodied and broadly described herein, the present invention further provides a light integration rod for uniforming the light beam provided by a light source of an optical projection apparatus. The light integration rod has an optical axis and includes a first integration portion. The first integration portion has a light incident surface perpendicular to the optical axis and located adjacent to the light source, wherein the first integration portion is composed of a prism-like portion and at least an oblique-pyramid-like portion. The oblique-pyramid-like portion has a base located on the light incident surface and is protruded from a cross-section of the first integration. The cross-sections of the oblique-pyramid-like space are gradually shrunk from the light incident cross-section along a direction away from the light emerging surface.

In summary, in the light integration rod and the optical projection apparatus of the present invention, the light integration rod has oblique-pyramid-like spaces or oblique-pyramid-like portions, which are able to enlarge the area of the light incident cross-section and further helpful to increase the light-collecting efficiency and the optical efficiency of the light integration rod.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a 3-D diagram of a conventional light integration rod.

FIG. 1B is the three view drawing of the light integration rod of FIG. 1A.

FIG. 1C is a sectional diagram of the light integration rod of FIG. 1A along the light incident cross-section.

FIG. 1D is a diagram illustrating the light-collecting efficiency and the distribution diagram of light intensity vs. included angle between light ray provided by the light source and the optical axis at the light incident cross-section of a conventional light integration rod.

FIG. 1E is a diagram illustrating the optical efficiency and the distribution diagram of light intensity vs. included angle between light ray provided by the light source and the optical axis at the light emerging cross-section of a conventional light integration rod.

FIG. 2A is a 3-D diagram of the light integration rod according to the first embodiment of the present invention.

FIG. 2B is the three view drawing of the light integration rod of FIG. 2A.

FIG. 2C is a diagram showing the optical path within an oblique-pyramid-like space of the light integration rod of FIG. 2A after a light ray is incident into the space.

FIG. 3 is a 3-D diagram of the light integration rod according to the second embodiment of the present invention.

FIG. 4A is a 3-D diagram of the light integration rod according to the third embodiment of the present invention.

FIG. 4B is the three view drawing of the light integration rod of FIG. 4A.

FIG. 4C is a sectional diagram of the light integration rod of FIG. 4A along the light incident cross-section.

FIG. 4D is a diagram illustrating the light-collecting efficiency increment of the light integration rod 400 when adding a single oblique-pyramid-like space and the distribution diagram of light intensity vs. included angle between light ray within the space and the optical axis at the light incident cross-section according to the third embodiment.

FIG. 4E is a diagram illustrating the light-collecting efficiency and the distribution diagram of light intensity vs. included angle between light ray provided by the light source and the optical axis at the light incident cross-section of the light integration rod according to the third embodiment.

FIG. 4F is a diagram illustrating the optical efficiency and the distribution diagram of light intensity vs. included angle between light ray provided by the light source and the optical axis at the light emerging cross-section of the light integration rod according to the third embodiment.

FIG. 5A is a 3-D diagram of the light integration rod according to the fourth embodiment of the present invention.

FIG. 5B is the three view drawing of the light integration rod of FIG. 5A.

FIG. 6A is a 3-D diagram of the light integration rod according to the fifth embodiment of the present invention.

FIG. 6B is the three view drawing of the light integration rod of FIG. 6A.

FIG. 7 is a diagram of the light integration rod according to the sixth embodiment of the present invention.

FIG. 8 is a structure diagram of an optical projection apparatus according to an embodiment of the present invention.

FIG. 9 is a diagram showing the relationship between a light beam cross-section output from a light integration rod and a light valve.

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “comprising,” or “having” and variations thereof herein is meant to encompass the items listed thereafter and equivalents thereof as well as additional items. Unless limited otherwise, the terms “connected,” and variations thereof herein are used broadly and encompass direct and indirect connections. Similarly, “adjacent to” and variations thereof herein are used broadly and encompass directly and indirectly “adjacent to”. Therefore, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

### The First Embodiment

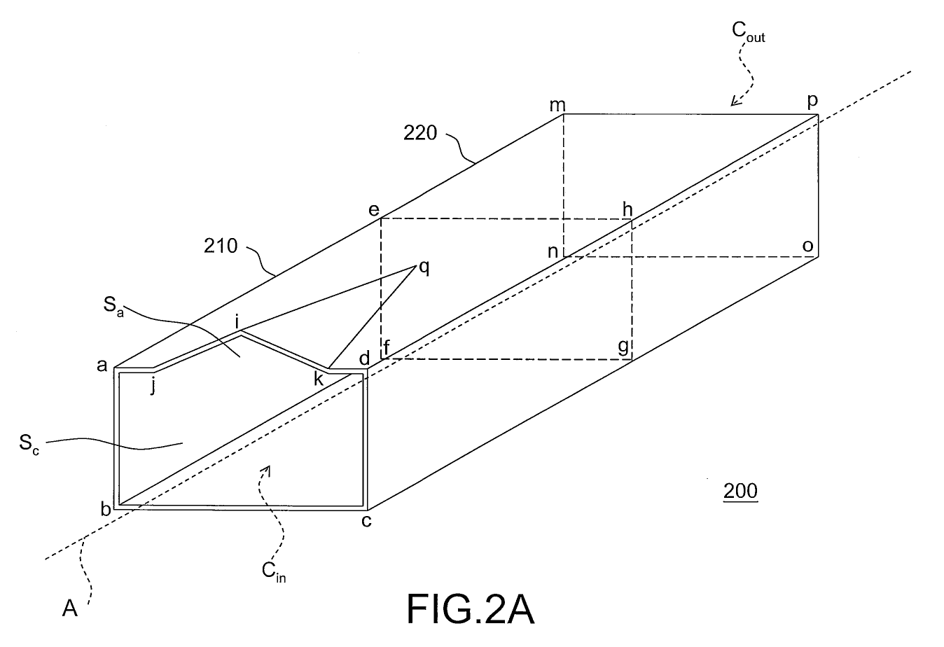

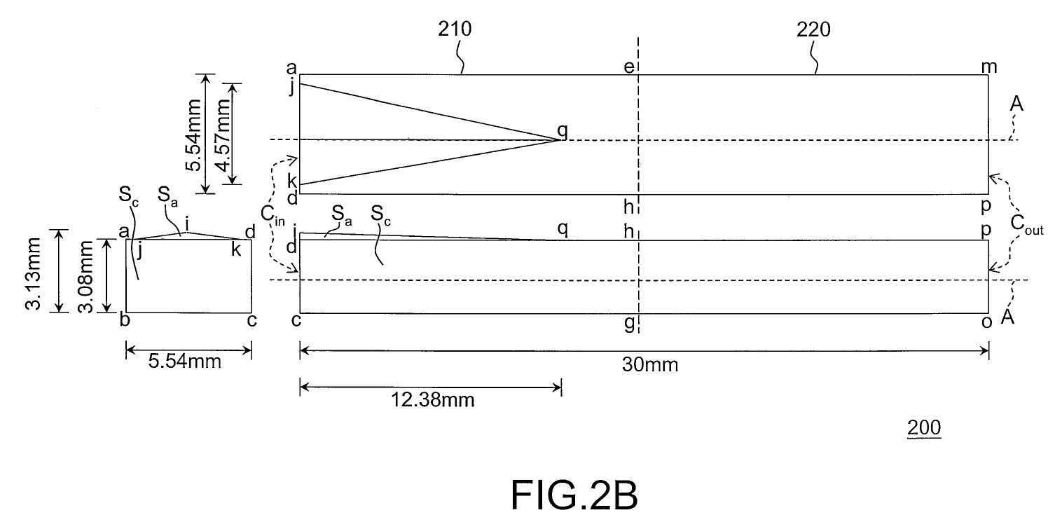

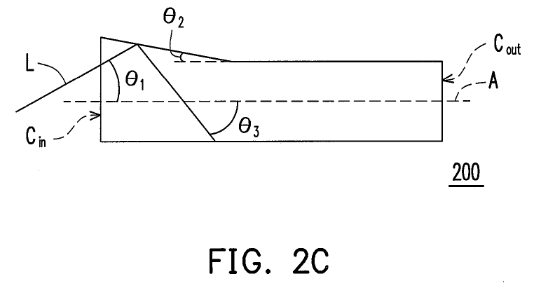

FIG. 2A is a 3-D diagram of the light integration rod according to the first embodiment of the present invention and FIG. 2B is the three view drawing of the light integration rod of FIG. 2A. Referring to FIGS. 2A and 2B, the light integration rod 200 of the embodiment is suitable for uniforming the light beam (not shown) provided by the light source of an optical projection apparatus (not shown). The light integration rod 200 has an optical axis A and includes a first integration portion 210 and a second integration portion 220, wherein the first integration portion 210 is connected to the second integration portion 220. The first integration portion 210 and the second integration portion 220 respectively have a light incident cross-section Cᵢₙ and a light emerging cross-section Cₒᵤₜ, both of which are perpendicular to the optical axis A. The light incident cross-section Cᵢₙ is located adjacent to the light source, while the light emerging cross-section Cₒᵤₜ is away from the light source. In other words, with respect to the light source, the first integration portion 210 is counted as the front end of the light integration rod 200, while the second integration portion 220 is counted as the rear end of the light integration rod 200, and the light incident cross-section Cᵢₙ is parallel to the light emerging cross-section Cₒᵤₜ.

Both the first integration portion 210 and the second integration portion 220 are hollow components. In particular, the space enclosed by the first integration portion 210 is composed of a prism-like space S_{c} and at least an oblique-pyramid-like space Sₐ, wherein the oblique-pyramid-like space Sₐ is protruded outward from the first integration portion 210; the cross-sections of the oblique-pyramid-like space Sₐ perpendicular to the optical axis A are gradually shrunk along a direction from the light incident cross-section Cᵢₙ to the light emerging cross-section Cₒᵤₜ.

Specifically, the prism-like space S_{c} is a cuboid space framed by eight points, a, b, c, d, e, f, g and h, while the oblique-pyramid-like space Sₐ is an oblique-tetrahedron-like space framed by four points, i, j, k and q, wherein the profile surface framed by the points j, k and q in the oblique-pyramid-like space Sₐ is located on the profile surface framed by the points a, d, h and e in the prism-like space S_{c}. In addition, the cross-section of the oblique-pyramid-like space Sₐ perpendicular to the optical axis A at the light incident cross-section Cᵢₙ is the base surface thereof framed by the points i, j and k, and cross-sections of the oblique-pyramid-like space Sₐ perpendicular to the optical axis A are gradually shrunk to the point q along the direction towards the light emerging cross-section Cₒᵤₜ (i.e. along the direction to away from the light incident cross-section Cᵢₙ).

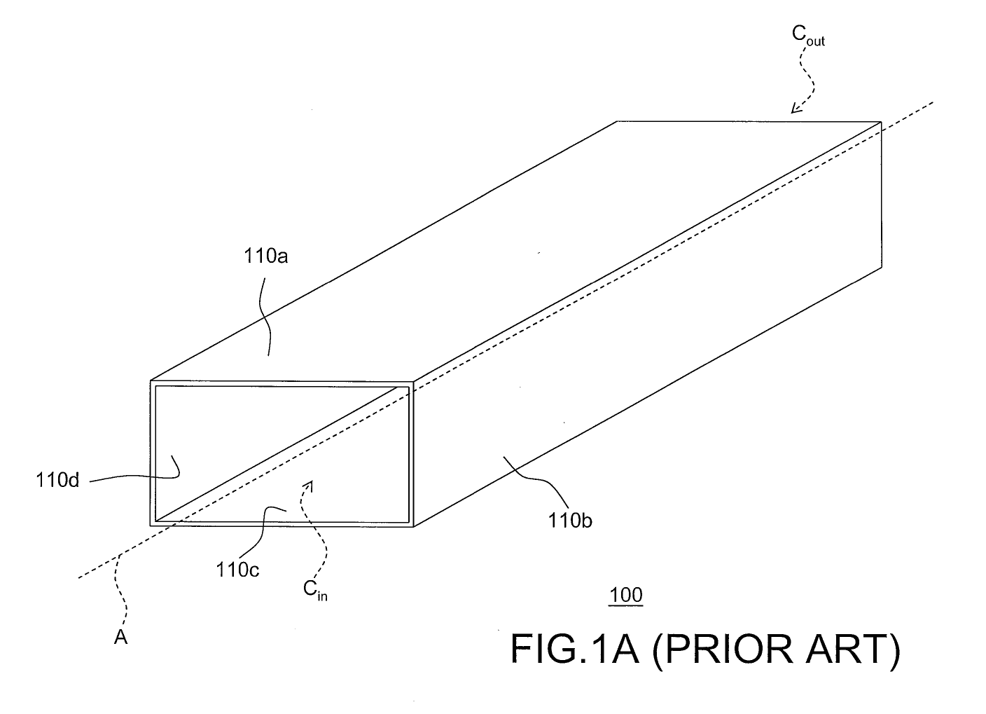

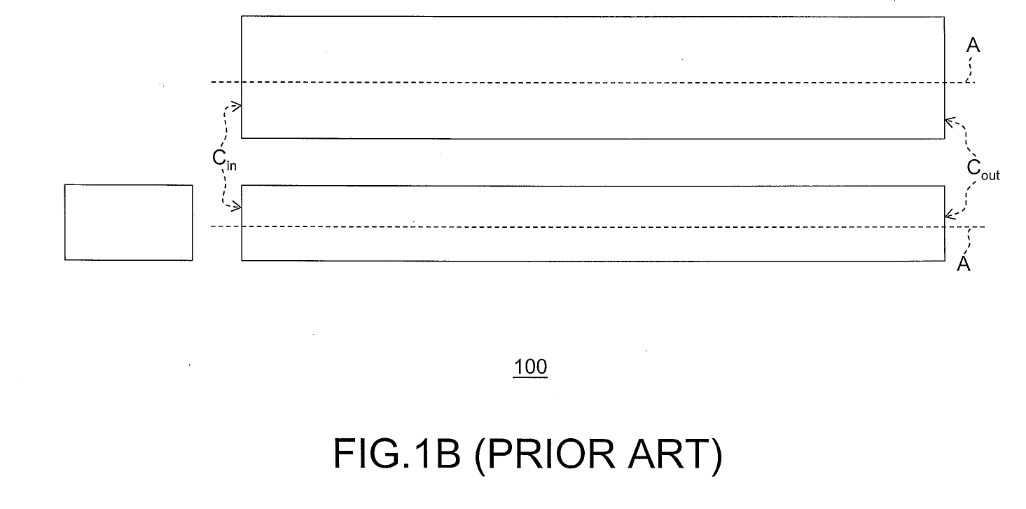

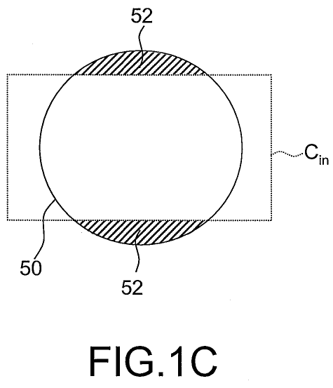

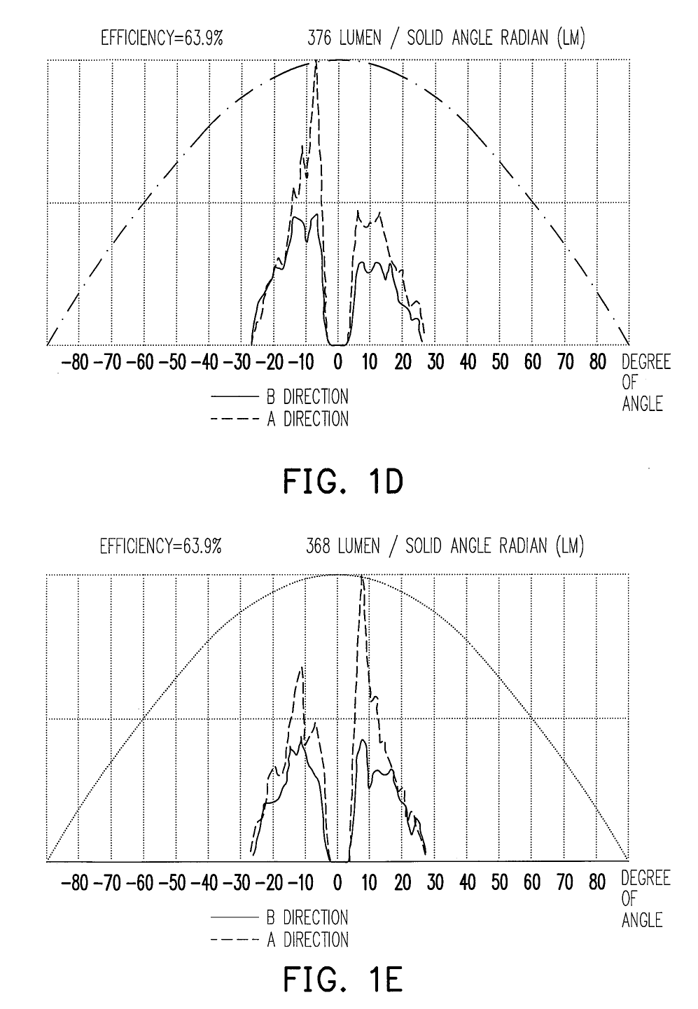

In other words, the light incident cross-section Cᵢₙ is the heptagon framed by the points a, b, c, d, k, i and j, wherein the heptagon is composed of the rectangle portion (framed by the points a, b, c and d) of the prism-like space S_{c} and the triangle portion (framed by the points i, j and k) of the oblique-pyramid-like space Sₐ. Therefore, in comparison with the light incident cross-section Cᵢₙ of the conventional light integration rod 100 (as shown by FIG. 1A), the light incident cross-section Cᵢₙ of the light integration rod 200 of the present invention has a larger light incident area, i.e., the triangle portion of the oblique-pyramid-like space Sₐ can collect the light beam falling in the region 52 (as shown by FIG. 1C) beyond the light incident cross-section Cᵢₙ of the light integration rod 100. Referring to FIG. 2C, a diagram showing the optical path within an oblique-pyramid-like space of the light integration rod of FIG. 2A after light is incident into the space, when the light L entering the oblique-pyramid-like space Sₐ of the light integration rod 200 is reflected, the included angle between the light L and the optical axis A is changed generally according to the equation, θ₃=θ₁+2θ₂; and every time the light L in the oblique-pyramid-like space Sₐ is reflected by the inner reflection surface with a wedge angle θ₂, the included angle between the light L and the optical axis A would be increased by 2θ₂. However, a part of the light beam entering the oblique-pyramid-like space Sₐ has small angle θ₁, in spite of increasing the light beam angle after multi-time reflections, much portion of the light beam just departing from the light emerging cross-section Cₒᵤₜ of the light integration rod 200 still has angles within the tolerable divergence angle range, which may be effectively used by the system and the light integration rod 200 of the embodiment accordingly has better light-collecting efficiency and optical efficiency.

In the embodiment, the second integration portion 220 may be a non-tapered integrator portion, i.e., the space enclosed by the second integration portion 220 is a cuboid space framed by the eight points e, f, g, h, m, n, o and p. However, the second integration portion 220 may be a tapered integrator portion or other appropriate integration portions as well.

The specific dimensions of the light integration rod 200 of the embodiment are given by FIG. 2B. In order to make a comparison with the conventional light integration rod 100, the profile dimension of the space (i.e. the cuboid space framed by the eight points a, b, c, d, m, n, o and p) composed of the prism-like space S_{c} of the first integration portion 210 and the space enclosed by the second integration portion 220 is the same as the light integration rod 100, i.e., 5.54 mm×3.08 mm×30 mm. In addition, an optical simulation is conducted on the assumption that the light source (represented by the light intensity A) and the tolerable divergence angle of the light integration rod 200 are the same as the light integration rod 100, so that the light beam intensity 5610 lm of the light integration rod 200 at the light emerging cross-section is obtained, which is higher than that (5482.5 lm) of the light integration rod 100 in FIG. 1A and indicates the light integration rod 200 of the embodiment has better optical efficiency.

In the embodiment, the prism-like space S_{c} is a cuboid space, while the oblique-pyramid-like space Sₐ is an oblique-tetrahedron-like space. However, the present invention does not limit the kinds of the prism-like space S_{c} and the oblique-pyramid-like space Sₐ. For example, the oblique-pyramid-like space Sₐ may be an oblique-pyramid-like space with a polygon base, such as an oblique-pyramid-like space with a tetragon base or an oblique-pyramid-like space with a pentagon base; the oblique-pyramid-like space Sₐ may be an oblique-pyramid-like space with a semi-circle base or an oblique-pyramid-like space with a semi-ellipse base as well. Note that the word ‘semi’ mentioned in the oblique-pyramid-like space with a semi-circle base and the oblique-pyramid-like space with a semi-ellipse base can not be literally interpreted, which generally refers to an incompleted circle or ellipse only.

The prism-like space S_{c} may be a polygonal-prism-like space, such as a prism-like space with a pentagon base or a prism-like space with a hexagon base; the prism-like space S_{c} may be a cylinder-like space or an ellipse-prism-like space as well. In order to facilitate assembling the light integration rod 200, the side length (connecting the points a and d) of the rectangle profile (framed by the points a, b, c and d) of the prism-like space S_{c} is longer than the side length (connecting the points j and k) of the triangle profile (framed by the points i, j and k) of the oblique-pyramid-like space Sₐ by design. However, in order to further advance the optical efficiency of the light integration rod 200, the present invention allows the point j to be coincident with the point a and the point k to be coincident with the point d.

Note that the lines and the points illustrated by the figures are geometric expressions only, for example, the expressions that the connection line between the points i and q represents a ridge edge line or the cross-sections of the oblique-pyramid-like space Sₐ perpendicular to the optical axis A would be shrunk to a point q. In fact, the real connection line between the points i and q or the real point q of the first integration portion 210 can take a chamfer structure during fabricating the light integration rod 200, which still belongs to the scope of the present invention.

The first integration portion 210 and the second integration portion 220 may be made of metal material with high reflectance and may be fabricated by metal punching process to form the shape shown by FIG. 2A. However, the present invention does not limit the material and the fabricating process of the first integration portion 210 and the second integration portion 220. For example, the first integration portion 210 and the second integration portion 220 may be fabricated by making a plurality of plastic plates adhere to each other and the inner walls of the plastic plates are plated with high-reflectance material.

### The Second Embodiment

Different from the above-described embodiment where the light integration rod is a hollow light integration rod, the second embodiment is related to a solid light integration rod, which is also covered by the spirit of the present invention.

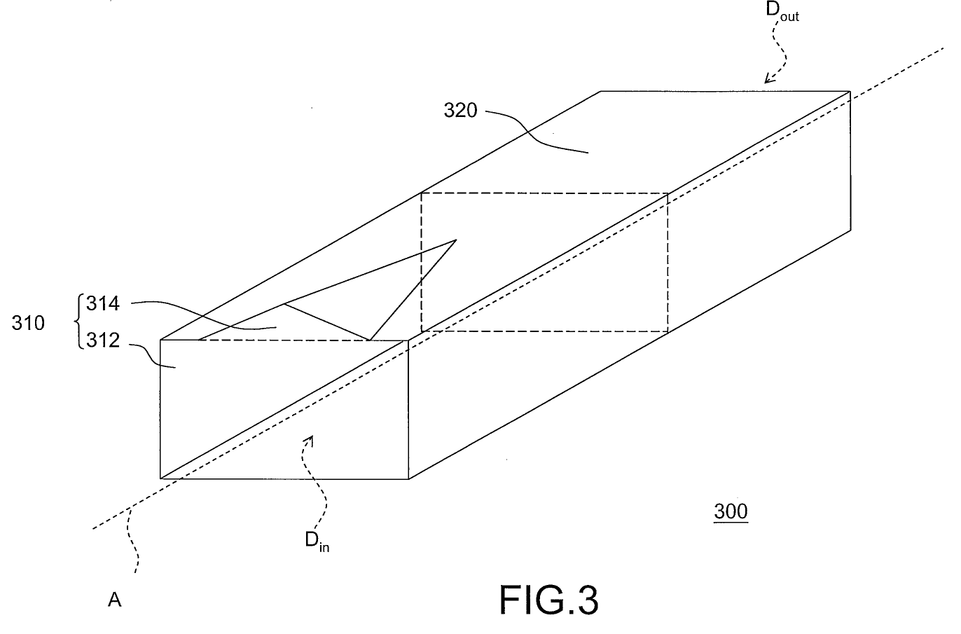

FIG. 3 is a 3-D diagram of the light integration rod according to the second embodiment of the present invention. Referring to FIG. 3, the light integration rod 300 of the embodiment is similar to the light integration rod 200 (as shown by FIG. 2A) of the first embodiment except that the light integration rod 300 of the embodiment is a solid light integration rod. The light integration rod 300 includes a first integration portion 310 and a second integration portion 320, wherein the first integration portion 310 and the second integration portion 320 are connected together and respectively have a light incident surface Dᵢₙ and a light emerging surface Dₒᵤₜ, both of which are perpendicular to the optical axis A. In addition, the light incident surface Dᵢₙ is located adjacent to the light source and the light emerging surface Dₒᵤₜ is away from the light source.

The first integration portion 310 and the second integration portion 320 are both solid components. In particular, the first integration portion 310 includes a prism-like portion 312 and at least an oblique-pyramid-like portion 314, wherein the oblique-pyramid-like portion 314 is protruded from the first integration portion 310 and the cross-sections perpendicular to the optical axis A of the oblique-pyramid-like portion 314 are gradually shrunk from the light incident surface Dᵢₙ along the direction away from the light incident surface Dᵢₙ. In addition, the second integration portion 320 is a non-tapered integrator portion.

Except for the light incident surface Dᵢₙ and the light emerging surface Dₒᵤₜ, the exposed outer surfaces of the first integration portion 310 and the second integration portion 320 are plated with reflective material, so that the light beam entering the light integration rod 300 from the light incident surface Dᵢₙ may be continuously reflected in the first integration portion 310 and the second integration portion 320 so as to have the uniform light beam, followed by exiting from the light emerging surface Dₒᵤₜ. As the above-described reason, the light integration rod of the embodiment also has higher optical efficiency.

In the embodiment, the prism-like portion 312 is, for example, a cuboid portion, while the oblique-pyramid-like portion 314 is, for example, a oblique-tetrahedron-like portion. However, similarly to the above described, the present invention does not limit the kinds of the prism-like portion 312 and the oblique-pyramid-like portion 314. In addition, the first integration portion 310 and the second integration portion 320 may be made of transparent material and fabricated by, for example, injection molding process.

In the light integration rod 200 (as shown by FIG. 2A) of the first embodiment and the light integration rod 300 (as shown by FIG. 3) of the second embodiment, the first integration portions 210 and 310 respectively include a single oblique-pyramid-like space Sₐ and a single oblique-pyramid-like portion 314. However, according to the present invention, a plurality of oblique-pyramid-like spaces Sₐ or a plurality of oblique-pyramid-like portions 314 may be used to further increase the optical efficiency of the light integration rod provided by the present invention. In the following, other embodiments concerning the hollow light integration rod having a plurality of oblique-pyramid-like spaces Sₐ are described. One skilled in the art has available in seeking to implement the teaching of this embodiments and modifies it to the embodiment concerning the solid light integration rod having a plurality of oblique-pyramid-like portions.

### The Third Embodiment

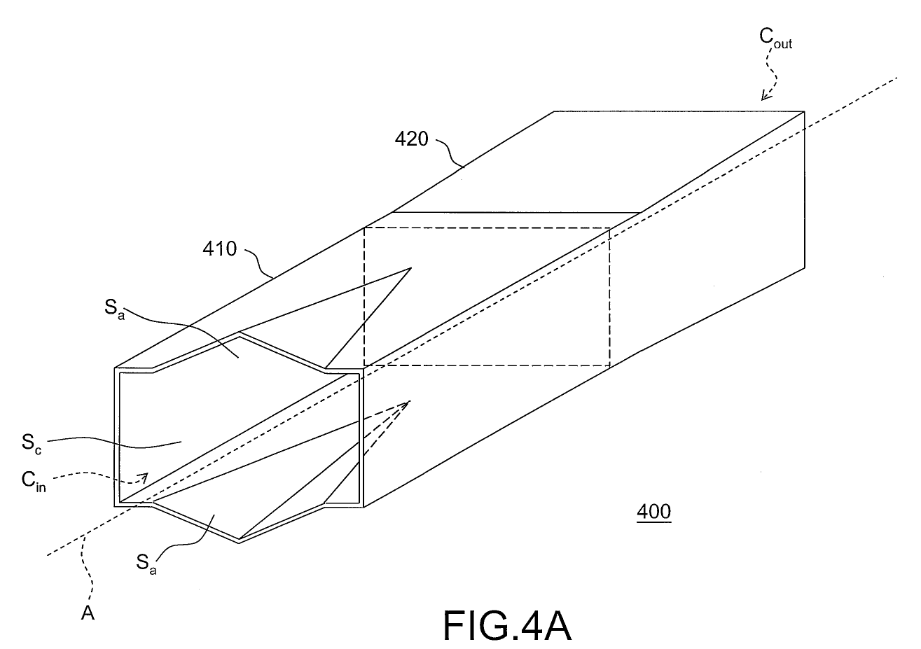

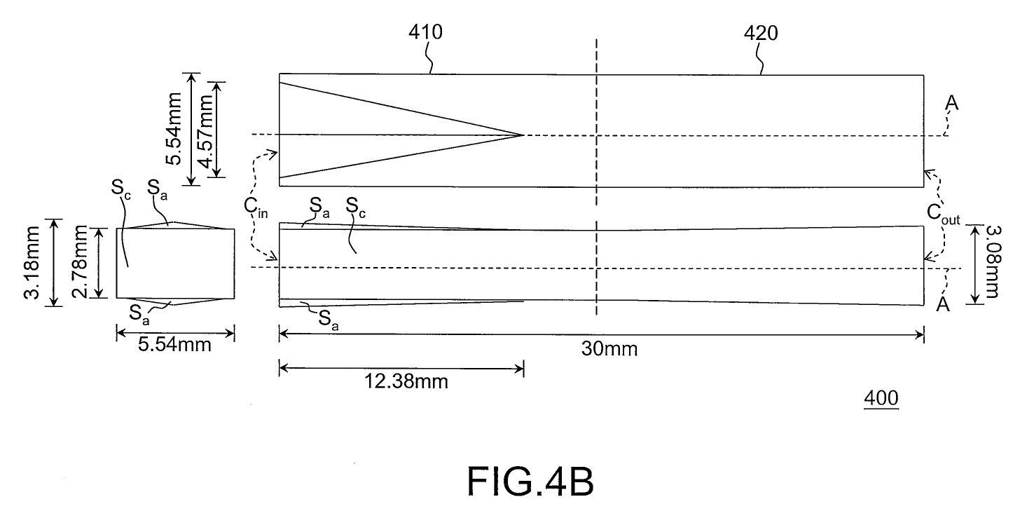

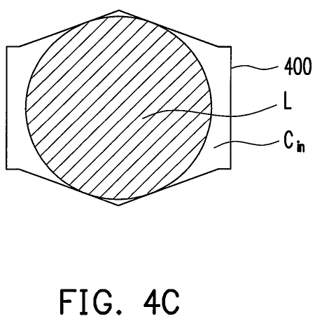

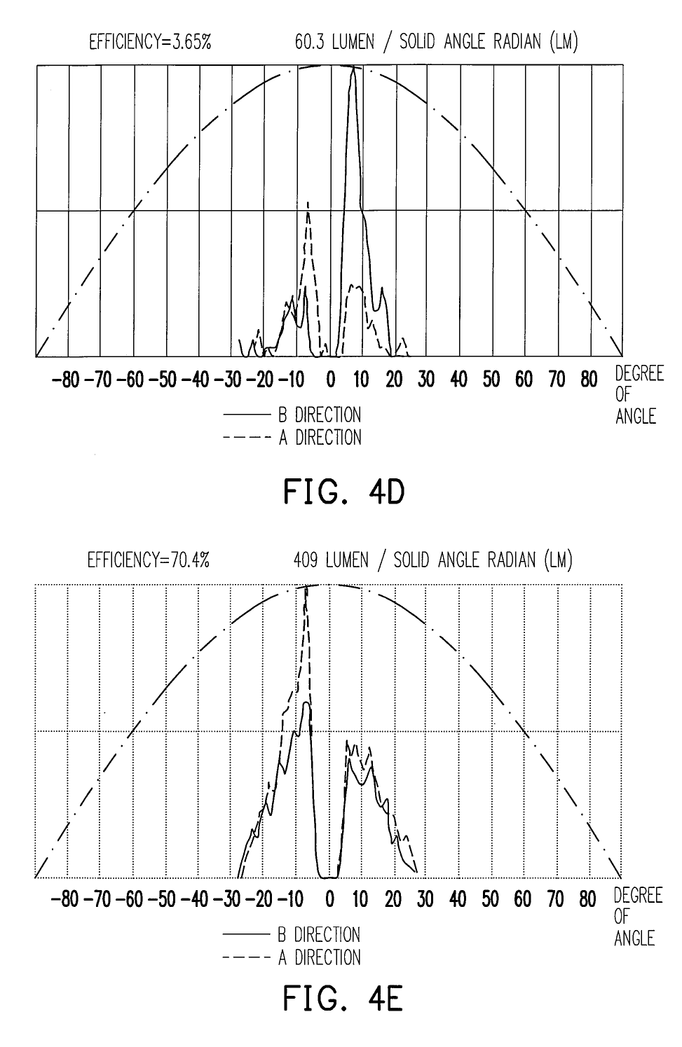

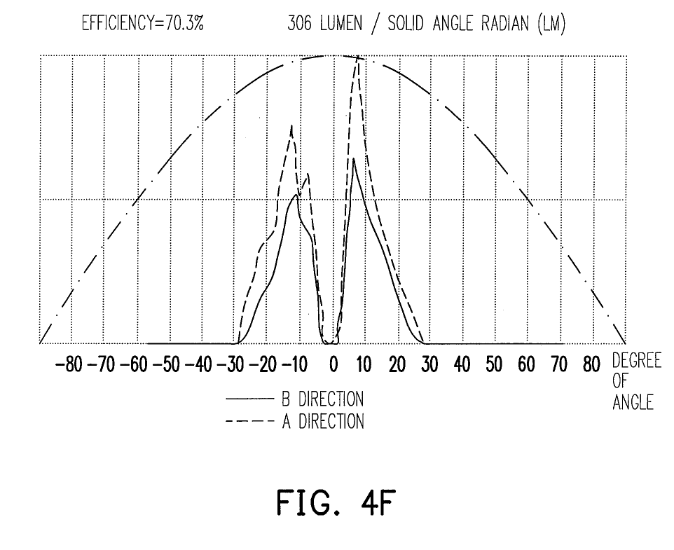

FIG. 4A is a 3-D diagram of the light integration rod according to the third embodiment of the present invention and FIG. 4B is the three view drawing of the light integration rod of FIG. 4A. Referring to FIGS. 4A and 4B, the light integration rod 400 according to this embodiment is similar to the light integration rod 200 (as shown by FIG. 2A) according to the first embodiment except that the space enclosed by the first integration portion 410 in the light integration rod 400 according to this embodiment is composed of a prism-like space S_{c} and two oblique-pyramid-like spaces Sₐ, wherein the protruded directions of the two oblique-pyramid-like spaces Sₐ from the first integration 410 are opposite to each other.

FIG. 4C is a sectional diagram of the light integration rod of FIG. 4A along the light incident cross-section. It is clear from FIG. 4C, the light L entering the light integration rod 400 through the light incident cross-section Cᵢₙ may be collected by the light integration rod 400 more effectively.

In order to make a comparison with the conventional light integration rod 100, the profile dimension of the space composed of the prism-like space S_{c} of the first integration portion 410 and the space enclosed by the second integration portion 420 is the same as the light integration rod 100, i.e., 5.54 mm×3.08 mm×30 mm (For the specific dimensions of the light integration rod 400, refer to FIG. 4B). In addition, an optical simulation is conducted on the assumption that the light source (represented by the light intensity A) and the tolerable divergence angle of the embodiment are the same as the light integration rod 100, so that the light beam intensity 5738.1 lm of the light integration rod 400 at the light emerging cross-section is obtained, which is higher than that (5482.5 lm) of the light integration rod 100 in FIG. 1A and indicates the light integration rod 400 of this embodiment has better optical efficiency.

Further, an optical simulation is conducted on the assumption that the profile dimension of the space composed of the prism-like space S_{c} of the first integration portion 410 and the space enclosed by the second integration portion 420 is 5.36 mm×3.65 mm×34.9 mm. Referring to FIG. 4D, the light-collecting efficiency of one of the oblique-pyramid-like spaces Sₐ obtained herein is 3.65% higher than that of conventional light integration rod. In addition, the incident angles of the light beams within the oblique-pyramid-like space Sₐ are smaller than 20°. Although the light beam angles are increased after multi-time reflections, the most portion of the outgoing light beams at the light emerging cross-section Cₒᵤₜ still has angles within the tolerable divergence angle range, which may be effectively used by the system. Referring to FIGS. 4E and 4F, assuming the total light throughout at the light source is 100%, the light-collecting efficiency of the light integration rod 400 of this embodiment at the light incident cross-section Cᵢₙ can reach 70.4%, while the optical efficiency of the light beam at the light emerging cross-section Cₒᵤₜ t can reach 70.3%. Therefore, in comparison with FIGS. 1D and 1E, the light integration rod 400 of the embodiment can largely increase the light-collecting efficiency and the optical efficiency.

### The Fourth Embodiment

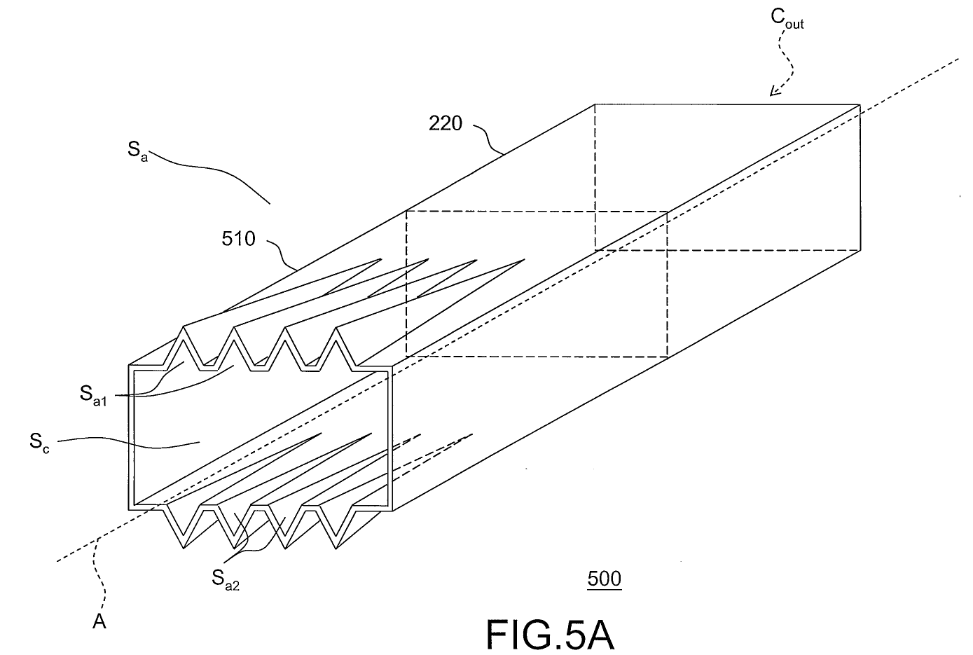

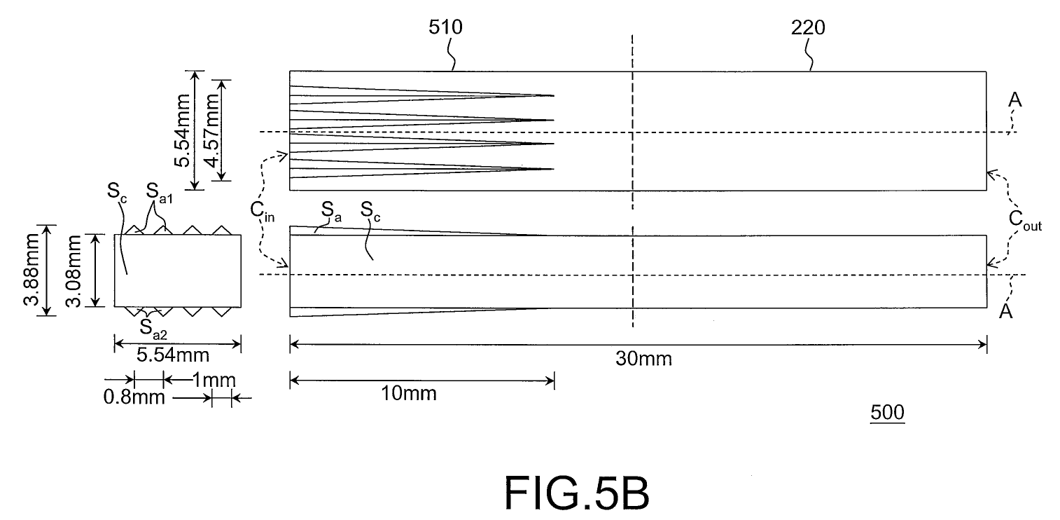

FIG. 5A is a 3-D diagram of the light integration rod according to the fourth embodiment of the present invention and FIG. 5B is the three view drawing of the light integration rod of FIG. 5A. Referring to FIGS. 5A and 5B, the light integration rod 500 of the embodiment is similar to the light integration rod 200 (as shown by FIG. 2A) of the first embodiment except that the space enclosed by the first integration portion 510 in the light integration rod 500 of this embodiment is composed of a prism-like space S_{c} and a plurality of oblique-pyramid-like spaces Sₐ₁ and Sₐ₂, wherein the protruded directions of the oblique-pyramid-like spaces Sₐ₁ from the first integration 410 are the same, the protruded directions of the oblique-pyramid-like spaces Sₐ₂ from the first integration 410 are the same, but the protruded directions of the oblique-pyramid-like spaces Sₐ₁ and the protruded directions of the oblique-pyramid-like spaces Sₐ₂ from the first integration 410 are opposite to each other.

In order to make a comparison with the conventional light integration rod 100, the profile dimension of the space composed of the prism-like space S_{c} of the first integration portion 510 and the space enclosed by the second integration portion 520 is the same as the light integration rod 100, i.e., 5.54 mm×3.08 mm×30 mm (For the specific dimensions of the light integration rod 500, refer to FIG. 5B). In addition, an optical simulation is conducted on the assumption that the light source (represented by the light intensity A) is the same as the light integration rod 100, so that the light beam intensity 5863 lm of the light integration rod 500 is obtained, which is higher than the that (5482.5 lm) of the light integration rod 100 in FIG. 1A and indicates the light integration rod 500 of this embodiment has better optical efficiency.

### The Fifth Embodiment

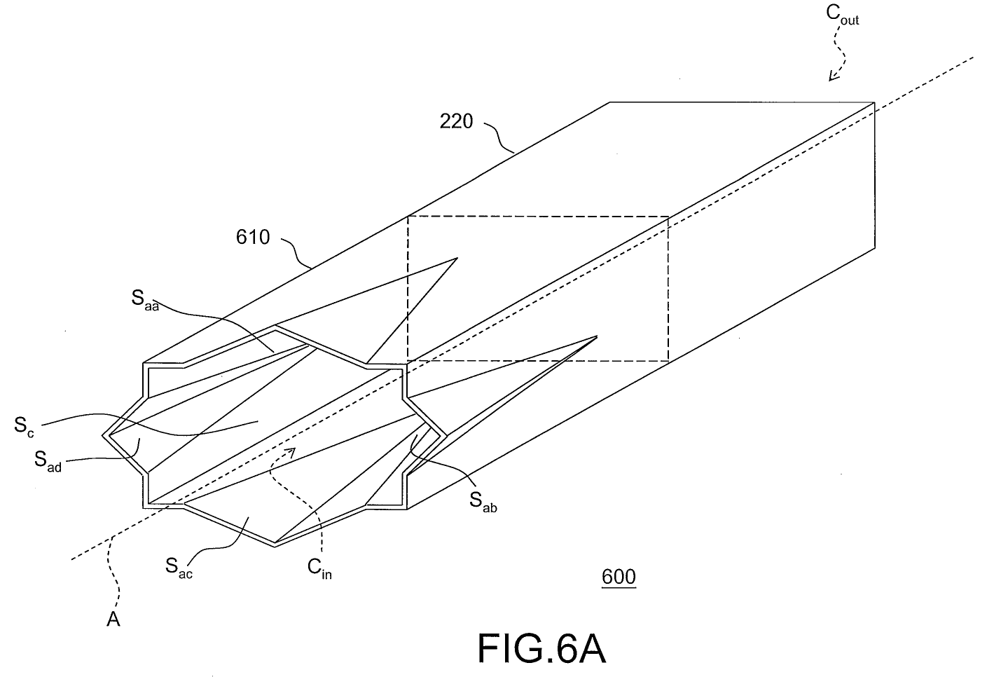

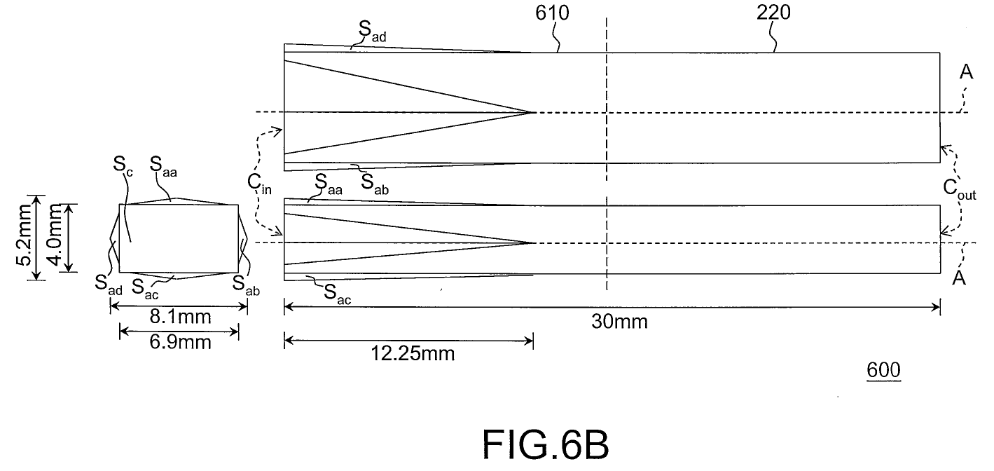

FIG. 6A is a 3-D diagram of the light integration rod according to the fifth embodiment of the present invention and FIG. 6B is the three view drawing of the light integration rod of FIG. 6A. Referring to FIGS. 6A and 6B, the light integration rod 600 of this embodiment is similar to the light integration rod 200 (as shown by FIG. 2A) of the first embodiment except that the space enclosed by the first integration portion 610 in the light integration rod 600 of this embodiment is composed of a prism-like space S_{c} and four oblique-pyramid-like spaces Sₐₐ, S_{ab}, S_{ac} and S_{ad}, wherein the protruded directions of the oblique-pyramid-like spaces Sₐₐ, S_{ab}, S_{ac} and S_{ad} from the first integration 410 are different from each other. In more detail, the protruded directions of the oblique-pyramid-like spaces Sₐₐ and S_{ac} from the first integration 410 are opposite to each other, while the protruded directions of the oblique-pyramid-like spaces S_{ab} and S_{ad} from the first integration 410 are opposite to each other.

An optical simulation is conducted on the profile dimension of light integration rod 600 is given by FIG. 6B, i.e. 6.9 mm×4.0 mm×30 mm and the arc gap of the light source is 1.0 mm, all of which are the same as the conventional light integration rod 100, so that the light beam intensity 6723.1 lm at the light emerging cross-section of the light integration rod 100 is obtained, while the light beam intensity 6857.7 lm at the light emerging cross-section of the light integration rod 600 is achieved, which indicates the light beam intensity of the light integration rod 600 is 2% higher than that of the conventional light integration rod 100. When the arc interval length becomes 1.3 mm due to the aging of the light source, the simulation results indicate that the light beam intensity of the conventional light integration rod 100 is 5917.7 lm, while the light beam intensity of the light integration rod 600 is 6377.5 lm, which indicates the light beam intensity of the light integration rod 600 is 7.8% higher than that of the conventional light integration rod 100. Therefore, the longer the operating time of a light source is, the larger the arc gap becomes, thus, the higher the difference of the light-collecting efficiency and the optical efficiency between this embodiment and the conventional ones will get, which results in that the optical projection apparatus of the present invention has a longer lifetime.

### The Sixth Embodiment

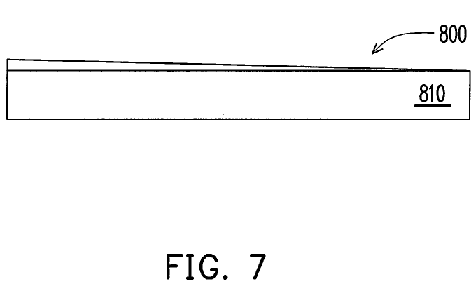

FIG. 7 is a diagram of the light integration rod according to the sixth embodiment of the present invention. Referring to FIG. 7, the light integration rod 800 of this embodiment is similar to the ones of the above-described embodiments, from the first embodiment to the fifth embodiment, except that the light integration rod 800 of this embodiment has a first integration portion 810 only without the second integration portion 220, 320 or 420 in the embodiments from the first one to the fifth one. In this embodiment, the first integration portion 810 may be designed as the first integration portion 210, 310, 410, 510 or 610 in the embodiments from the first one to the fifth one.

It noted that the feature of the present invention resides at the space enclosed by the first integration portion which is composed of a prism-like space and oblique-pyramid-like spaces protruded outward from first integration portion, and the present invention does not limit the quantity of the oblique-pyramid-like spaces, the relative positions between the oblique-pyramid-like spaces and the prism-like space and the dimensions of the components in the light integration rod. The above-mentioned embodiments are introduced for implementing the spirit of the present invention, not to limit the present invention.

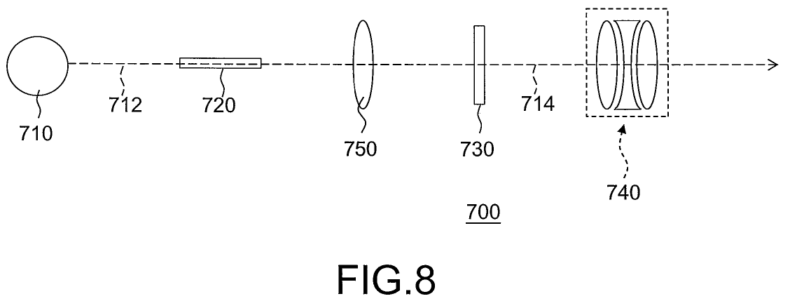

FIG. 8 is a structure diagram of an optical projection apparatus according to an embodiment of the present invention. The optical projection apparatus 700 of the present invention includes a light source 710, a light integration rod 720, a light valve 730, an imaging system 740 and a lens or a plurality of lenses 750, wherein the light integration rod 720 may be the same as the light integration rods of the above-mentioned embodiments (as shown by FIGS. 2A, 3, 4A, 5A and 6A) or other light integration rods having the features of the present invention. The light source 710 is suitable for providing an illumination light beam 712, the light integration rod 720 is disposed on the optical path of the illumination light beam 712 and suitable for uniforming the illumination light beam 712. The lens 750 is disposed on the optical path between the light integration rod 720 and the light valve 730. The illumination light beam 712 after being unformed by the light integration rod 720 passes the lens 750 and then hits the light valve 730. The light valve 730 is disposed on the optical path of the light beam 712 after passing the light integration rod 720 and suitable for converting the illumination light beam 712 into an image light beam 714. The imaging system 740 is disposed on the optical path of the image light beam 714 and suitable for projecting the image light beam 714 onto a screen to display images.

Since the optical projection apparatus 700 of the present invention has a light integration rod 720 with better optical efficiency, the optical projection apparatus 700 has better display quality. As the cross-section area of the light beam 712 gets larger due to aging of the light source 710, the decay of the optical efficiency of the light integration rod 720 is lower than that of the conventional light integration rod 100. Therefore, the optical projection apparatus 700 has a longer lifetime.

In this embodiment, the light source 710 may be, for example, an arc-discharge lamp and the types of the arc-discharge lamp may be a metal-halide lamp or an ultra high pressure mercury lamp (UHP), and so on. The light source 710 may be a light emitting diode (LED) or a laser light source too. Besides, the optical projection apparatus 700 of this embodiment takes the framework of transmissive-type projection, while the light valve 730 is, for example, a transmisssive-type LCD. On the other hand, the optical projection apparatus 700 can take the framework of reflective-type projection, while the light valve 730 is a digital micro-mirror device (DMD) or a liquid crystal on silicon (LCOS) panel.

In order to increase the positioning accuracies between the components in the optical projection apparatus 700, a fixing mechanism, for example a housing, may be used for positioning the components thereof. Anyone skilled in the art can also make some modifications without departing from the spirit of the present invention, which still belongs to the scope of the present invention.

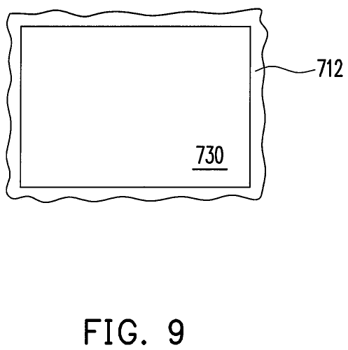

FIG. 9 is a diagram showing the relationship between a light beam cross-section output from a light integration rod and a light valve. Referring to FIGS. 8 and 9, the light emerging cross-section Cₒᵤₜ of the light integration rod 720 may be so designed that the ratio between length and width thereof is substantially the same as or similar to that of the light valve 730, so as to make the illumination light beam 712 provided by the light integration rod 720 fully falled onto the light valve 730.

In summary, the light integration rod and the optical projection apparatus of the present invention have at least the following advantages:

1. Since the light integration rod has oblique-pyramid-like spaces (oblique-pyramid-like portions), the oblique-pyramid-like spaces (oblique-pyramid-like portions) are able to increase the area of the light incident cross-section to advance the light-collecting efficiency and are also helpful to advance the optical efficiency of the light integration rod.

2. Since the optical projection apparatus of the present invention has the light integration rod with higher optical efficiency, the optical projection apparatus has better quality.

3. In comparison with the prior art, when the cross-section area of the light beam gets larger due to aging of the light source, the decay extent of the optical efficiency of the light integration rod according to the present invention is lighter and the ununiformity of the projected images is reduced. In this way, the optical projection apparatus of the present invention has longer lifetime.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light integration rod for uniforming a light beam provided by a light source of an optical projection apparatus and having an optical axis, comprising:
a first integration portion, having a light incident cross-section perpendicular to said optical axis and located adjacent to said light source, wherein a space enclosed by said first integration portion is composed of a prism-like space and at least an oblique-pyramid-like space protruded from a cross-section of said first integration portion, and a cross-sections of said oblique-pyramid-like space perpendicular to said optical axis are gradually shrunk from said light incident cross-section in the direction away from the light incident cross-section.

2. The light integration rod according to claim 1, wherein a number of said oblique-pyramid-like spaces is more than one, and the protruded directions of said oblique-pyramid-like spaces from a cross-section of said first integration portion are the same as each other, opposite to each other or different from each other.

3. The light integration rod according to claim 1, wherein the oblique-pyramid-like space is an oblique-pyramid-like space with a polygon base, an oblique-pyramid-like space with a semi-circle base or an oblique-pyramid-like space with a semi-ellipse base.

4. The light integration rod according to claim 1, wherein the prism-like space is a polygonal-prism-like space, a cylinder-like space or an ellipse-prism-like space.

5. The light integration rod according to claim 1, further comprising a second integration portion connecting with the first integration portion, wherein the second integration portion has a light emerging cross-section parallel to the light incident cross-section and away from the light source.

6. The light integration rod according to claim 5, wherein the second integration portion is a tapered integrator portion or a non-tapered integrator portion.

7. An optical projection apparatus, comprising:
a light source for providing an illumination light beam;
a light integration rod, disposed on an optical path of said illumination light beam and having an optical axis; said light integration rod comprising:
a first integration portion, having a light incident cross-section perpendicular to said optical axis and located adjacent to said light source, wherein said illumination light beam is incident into said light integration rod from said light incident cross-section in a direction parallel to said optical axis, a space enclosed by said first integration portion is composed of a prism-like space and at least an oblique-pyramid-like space protruded from a cross-section of said first integration portion, and the cross-sections of said oblique-pyramid-like space perpendicular to the optical axis are gradually shrunk from the light incident cross-section in the direction away from the light incident cross-section;
a light valve, disposed on the optical path of the illumination light beam after passing through the light integration rod and suitable for converting the illumination light beam into an image light beam; and
an imaging system, disposed on the optical path of the image light beam.

8. The optical projection apparatus according to claim 7, wherein a number of said oblique-pyramid-like spaces is more than one, and the protruded directions of said oblique-pyramid-like spaces from a cross-section of said first integration portion are the same as each other, opposite to each other or different from each other.

9. The optical projection apparatus according to claim 7, wherein the oblique-pyramid-like space is an oblique-pyramid-like space with a polygon base, an oblique-pyramid-like space with a semi-circle base or an oblique-pyramid-like space with a semi-ellipse base.

10. The optical projection apparatus according to claim 7, wherein the prism-like space is a polygonal-prism-like space, a cylinder-like space or an ellipse-prism-like space.

11. The optical projection apparatus according to claim 7, wherein said light integration rod further comprises a second integration portion connecting with said first integration portion, and said second integration portion has a light emerging cross-section parallel to the light incident cross-section and away from the light source.

12. The optical projection apparatus according to claim 11, wherein said second integration portion is a tapered integrator portion or a non-tapered integrator portion.

13. A light integration rod for uniforming the light beam provided by a light source of an optical projection apparatus and having an optical axis, comprising:
a first integration portion, having a light incident surface perpendicular to the optical axis and located adjacent to the light source, wherein said first integration portion is composed of a prism-like portion and at least an oblique-pyramid-like portion protruded from a surface of said first integration portion, and a cross-section of said oblique-pyramid-like portion perpendicular to said optical axis are gradually shrunk from said light incident surface in the direction away from said light incident surface.

14. The light integration rod according to claim 13, wherein said prism-like portion is a polygonal-prism-like portion.

15. The light integration rod according to claim 13, wherein a number of said oblique-pyramid-like portions is more than one, and said oblique-pyramid-like portions are respectively protruded from two opposite surfaces, two adjacent surfaces or a surface of said first integration portion.

16. The light integration rod according to claim 13, wherein said oblique-pyramid-like portion is an oblique-pyramid-like portion with a polygon base, an oblique-pyramid-like portion with a semi-circle base or an oblique-pyramid-like portion with a semi-ellipse base.

17. The light integration rod according to claim 13, wherein said prism-like portion is a cylinder-like portion or an ellipse-prism-like portion.

18. The light integration rod according to claim 13, further comprising a second integration portion connecting with said first integration portion, wherein said second integration portion has a light emerging surface parallel to said light incident surface and away from the light source.

19. The light integration rod according to claim 18, wherein said second integration portion is a tapered integrator portion or a non-tapered integrator portion.
